(19) United States
(12) Patent Application Publication
(10) Pub. No.: US 2006/0157109 A1
(43) Pub. Date: Jul. 20, 2006

(54) Air gap apparatus for water dispenser

(75) Inventor: Vinh Vu, Lawndale, CA (US)

Correspondence Address: CARLSON, GASKEY & OLDS, P.C., 400 WEST MAPLE ROAD, SUITE 350, BIRMINGHAM, MI, 48009, US

(73) Assignee: Brasstech Inc.

(21) Appl. No.: 11/067,344

(22) Filed: Feb. 25, 2005

Related U.S. Application Data
(60) Provisional application No. 60/644,382, filed on Jan. 14, 2005.

(51) Int. Cl. F16K 1/04

(52) U.S. Cl. 137/216

(57) ABSTRACT

A faucet assembly includes an air gap assembly disposed within a lower housing onto which is assembled a faucet assembly. The faucet assembly substantially conceals the air gap assembly within the lower housing. The faucet is mounted atop the lower housing. The lower housing includes an outer surface that corresponds to an outer surface of the upper housing such that the two housings provide a substantially continuous and mated appearance. The design and shape of the upper housing and the lower housing provide for an integrated faucet assembly that includes the air gap assembly substantially concealed within the faucet.

The application claims priority to U.S. Provisional Application No. 60/644,382, which was filed on Jan. 14, 2005.

### BACKGROUND OF THE INVENTION

An auxiliary faucet such as for a reverse osmosis system provides filtered water. A conventional reverse osmosis system includes a filter that separates impurities from water. The water that does not pass through the filter is carried into a waste water pipe and out a drain. Typically, a drainpipe is required to include an air gap to prevent back flow of wastewater.

The air gap is typically provided by a remotely located device with conduits that lead back to the reverse osmosis system. The remotely located air gap device is often installed on the same mounting surface as the faucet to comply with installation requirements. As appreciated, a counter installed air gap device may not be a desirable addition in installations having limited space.

Accordingly, it is desirable to develop an air gap device for use with a reverse osmosis faucet that is installable with limited space and provides a desirable appearance.

### SUMMARY OF THE INVENTION

An example faucet assembly according to this invention includes an air gap assembly disposed within a lower housing onto which is assembled a faucet assembly for substantially concealing the air gap assembly.

The reverse osmosis faucet assembly includes the faucet and the air gap assembly. The faucet is mounted atop the lower housing including the air gap assembly. A reverse osmosis system supplies potable water to an inlet and the remaining wastewater is communicated from a first conduit through the air gap assembly and out a second conduit to a drain.

The air gap assembly is disposed within the lower housing and conforms to an upper housing of the faucet. The lower housing includes an outer surface that continues an outer surface of the upper housing such that the two housings provide a substantially continuous and mated appearance. The design and shape of the upper housing and the lower housing provide for an integrated faucet assembly that includes the air gap assembly that is substantially concealed within the faucet.

Accordingly, the example faucet assembly of this invention provides a reverse osmosis faucet that is installable with limited space and that provides a desirable appearance while providing the desired air gap.

These and other features of the present invention can be best understood from the following specification and drawings, the following of which is a brief description.

### BRIEF DESCRIPTION OF THE DRAWINGS

FIG. 1 is a perspective view of an example reverse osmosis faucet assembly.

FIG. 2 is a partial exploded view of an example faucet assembly and air gap assembly according to this invention.

FIG. 3 is a perspective view of an example air gap assembly.

FIG. 4 is an exploded view of the example air gap assembly.

FIG. 5 is a top view of the example air gap assembly.

FIG. 6 is a cross-sectional view of the air gap assembly.

FIG. 7 is another cross-sectional view of the air gap assembly.

FIG. 8 is a partial sectional view of the example faucet housing according to this invention.

FIG. 9 is another partial sectional view of the example faucet housing.

FIG. 10 is a partially exploded view of a mounting process for the Faucet assembly.

FIG. 11 is a partial cross-sectional view of the faucet assembly mounted to a mounting surface.

### DETAILED DESCRIPTION OF THE PREFERRED EMBODIMENT

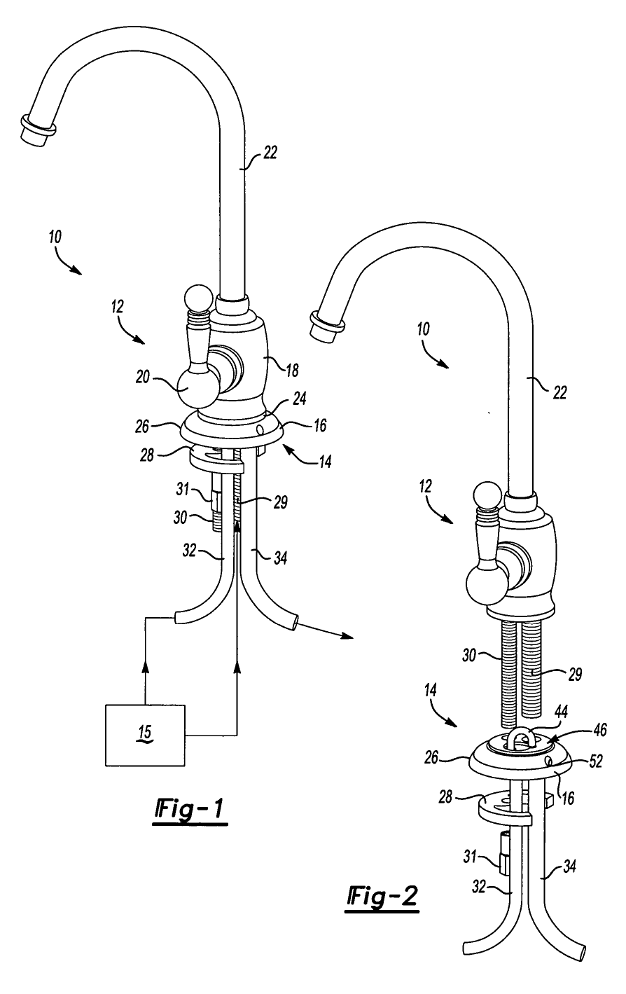

Referring to FIGS. 1 and 2, a reverse osmosis faucet assembly 10 includes a faucet 12 and an air gap assembly 14. The faucet 12 includes a valve 20 for controlling the flow of water and a spout 22 for directing the flow of water. The faucet 12 is mounted by way of a threaded rod 30 that extends through a mounting bracket 28 and threadingly engages a mounting nut 31. The example faucet 12 is for a reverse osmosis system 15 including a filter for separating impurities from the water. The reverse osmosis system 15 operates by flowing water to a filter in which relatively clean water permeates through the filter and wastewater is directed toward a drain. A water inlet 29 provides water to the valve 20 from the reverse osmosis system 15. Wastewater from the reverse osmosis system 15 is communicated through the first conduit 32 through the air gap assembly 14, and to a drain through a second conduit 34.

The air gap assembly 14 includes a lower housing 16 that conforms to an upper housing 18 of the faucet 12. The lower housing 16 includes an outer surface 26 that continues and substantially matches an outer surface 24 of the upper housing 18 such that the two housings 16, 18 provide a substantially continuous and mated appearance. The specific design and shape of the upper housing 18 and the lower housing 16 provide an integrated faucet assembly 10 that includes the air gap assembly 14 in a substantially concealed configuration within the faucet 12.

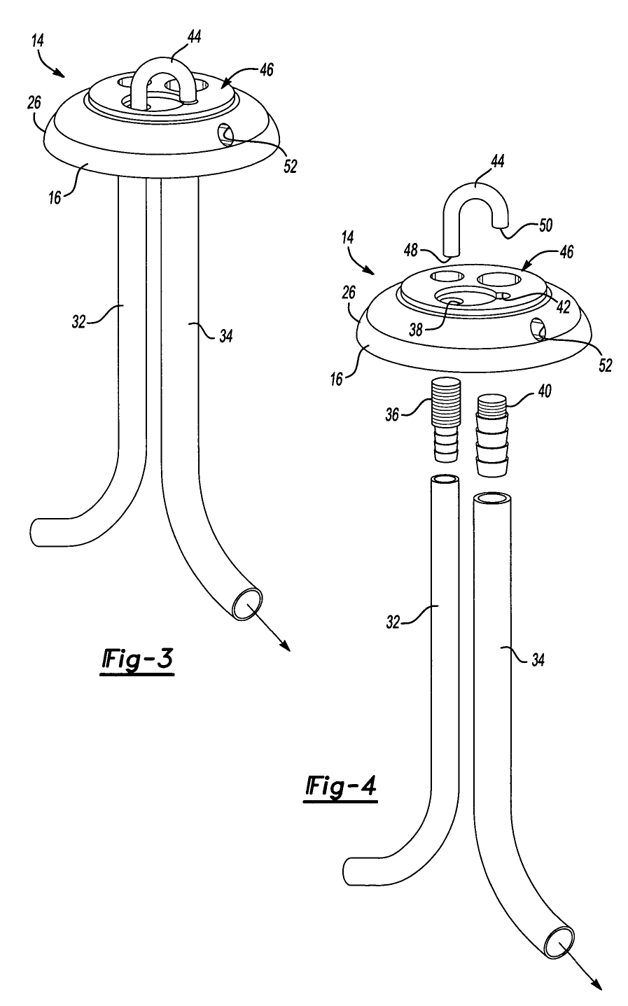

Referring to FIGS. 3 and 4, the air gap assembly 14 includes the first conduit 32 that is joined and mounted to the lower housing 16 by way of a first adaptor 36. The second conduit 34 is joined and mounted to the lower housing 16 by way of a second adaptor 40 that corresponds with a second opening 42. The first adaptor 36 is attached adjacent a first opening 38 and includes a J-shaped tube 44. The J-shaped tube 44 includes a first end 48 that is mounted within the first adaptor 36 to direct wastewater between the first conduit 32 and into the second conduit 34. A second end 50 of the J-shaped tube 44 directs water into the second opening 42 and down through the second conduit 34 to a drain. The second opening 42 is in communication with an air inlet 52 that extends to the outer surface 26 of the lower housing 16.

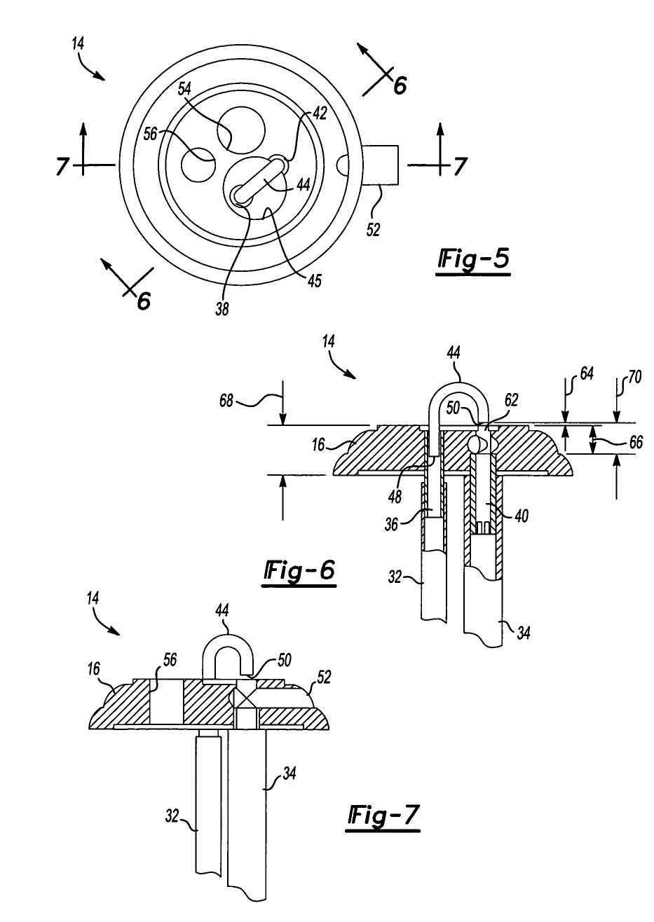

Referring to FIG. 5, the air gap assembly 14 includes opening 54 for the water inlet 29 and opening 56 for the threaded rod 30. The J-shaped tube 44 extends between the first opening 38 and the second opening 42 to expel wastewater and provide the desired air gap 62 therebetween. The air inlet 52 provides for the communication of atmosphere to the second opening 42 to facilitate the desired air gap 62 between the J-shaped tube 44 and the second opening 42.

Referring to FIG. 6, the air gap 62 between the second end 50 of the J-shaped tube 44 and the second opening 42 prevent the back flow of water from the second conduit 34 into the first conduit 32. The air gap 62 comprises a spaced apart distance 70 between the second end 50 of the J-shaped tube 44 and the second adaptor 42. The distance 70 is disposed substantially within a height 68 of the lower housing 16. The distance 70 includes a first portion 66 disposed within the height 68 and a second portion 64 disposed just above the lower housing 16. The distance 70 is determined according to application specific and local requirements and regulation. However, the distance 70 is provide for substantially within the height 68 of the lower housing 16 to provide a low profile mounting arrangement that does not protrude far above the lower housing 16.

Referring to FIG. 7, the lower housing 16 includes the air inlet 52. In the example lower housing 16 the air inlet 52 is a horizontal passage in communication with the second opening 42. The air inlet 52 provides desired communication to atmosphere providing for the operation of the air gap assembly 14.

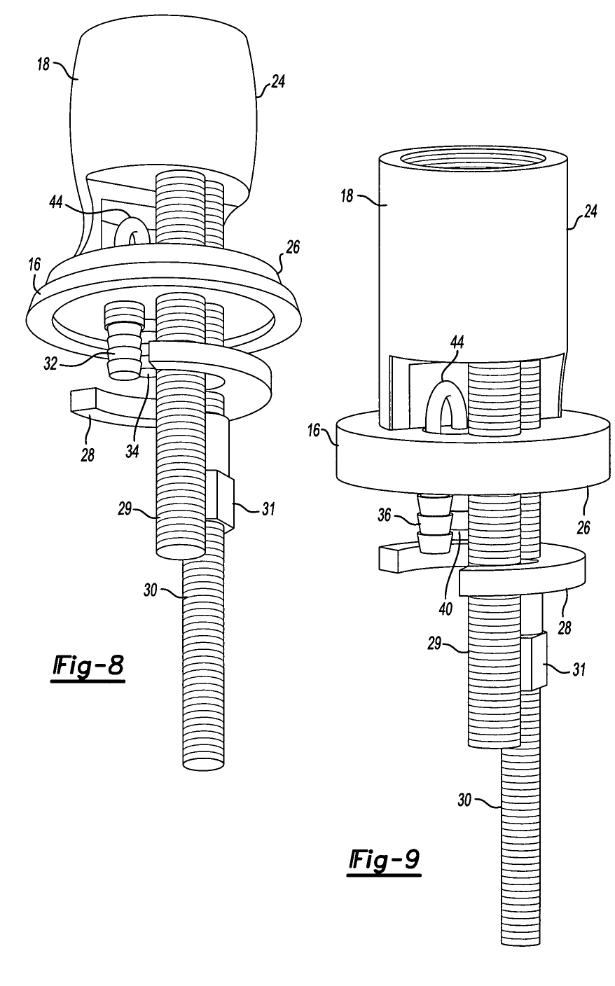

Referring to FIGS. 8 and 9, the J-shaped tube 44 is substantially disposed within the upper housing 18 when the upper housing 18 is mounted atop the lower housing 16. FIGS. 8 and 9 are partially cut-away views to show how the J-shaped tube 44 fits within the upper housing 18 once the faucet assembly 10 is fully assembled and mounted. As appreciated, concealing the J-shaped tube 44 within the upper housing 18 provides the desired air gap function without disrupting the desired appearance above the mounting surface.

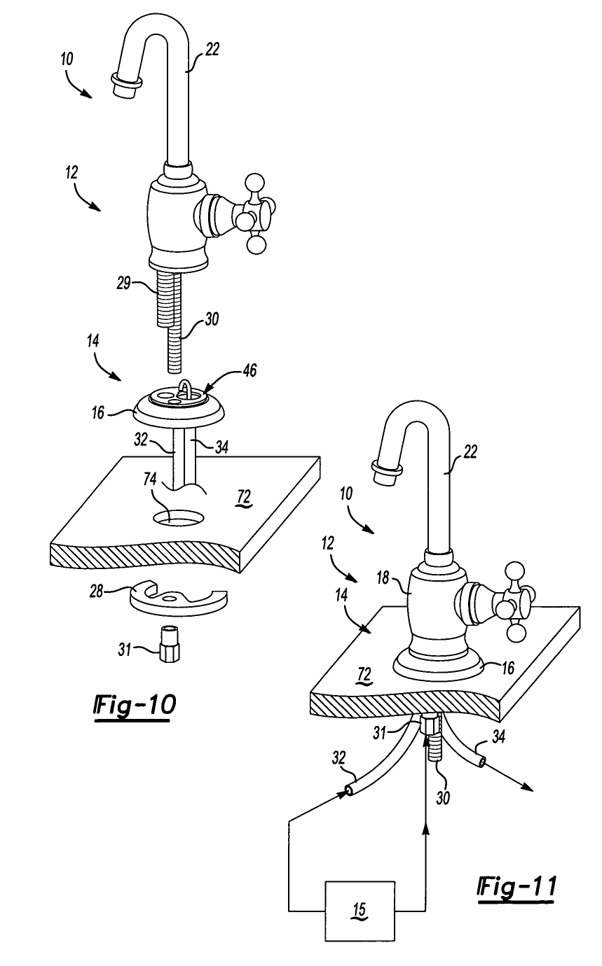

Referring to FIGS. 10 and 11, the faucet assembly 10 is shown being mounted to a desired mounting surface 72. The mounting surface 72 includes an opening 74 for the first and second conduits 32,34, the water inlet 29 and the threaded rod 30. The air gap assembly 14 is placed over the opening 74 and the first and second conduits 32,34 are received through the opening 74. The faucet 12 is then placed onto the mounting surface 46 of the lower housing 16. The threaded rod 30 and the water inlet 29 extend through corresponding openings 56 and 54 within the lower housing 16. The threaded rod 30 is inserted into the mounting bracket 28 below the mounting surface 72 and the mounting nut 31 assembled to the threaded rod 30 to secure the faucet 12 in place. The water inlet 29 is then connected to a supply line from the reverse osmosis system 15 and the first conduit 32 attached to receive wastewater from the reverse osmosis system 15. Assembly is completed by securing the second conduit 34 to a drain line.

The assembled faucet assembly 10 conceals the air gap assembly 14 such that the faucet assembly 10 operates as desired without disrupting a desired appearance.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A reverse osmosis faucet assembly comprising:
a lower housing mountable to a mounting surface and having a first conduit, and a second conduit;
an air gap device disposed within said lower housing for directing wastewater from said first conduit to said second conduit; and
an upper housing including a water control valve and an inlet conduit for supplying water to said water control valve.

2. The assembly as recited in claim 1, wherein said lower housing includes a height, and said air gap device includes an air gap that is disposed at least partially within said height.

3. The assembly as recited in claim 2, wherein said air gap device includes an inverted J-shaped tube disposed between said first conduit and said second conduit.

4. The assembly as recited in claim 3, wherein said J-shaped tube includes a first end in direct communication with said first conduit and a second end spaced a distance from an opening to said second conduit.

5. The assembly as recited in claim 4, wherein said distance between said opening and said second end is equal to or greater than a height of said lower housing.

6. The assembly as recited in claim 4, wherein said air gap includes a first portion disposed within said height of said lower housing, and a second portion disposed outside said lower housing.

7. The assembly as recited in claim 6, wherein said first portion is greater than said second portion.

8. The assembly as recited in claim 1, wherein said upper housing is mountable atop said lower housing.

9. The assembly as recited in claim 8, wherein said lower housing includes an outer surface that corresponds with an outer surface of said upper housing.

10. The assembly as recited in claim 8 wherein said air gap device is disposed within said upper housing when said upper housing is mounted to said lower housing.

11. An air gap assembly for a reverse osmosis faucet comprising:
a housing mountable to a mounting surface, said housing having a height above the mounting surface;
a first conduit;
a second conduit; and
an air gap tube attached at a first end to the first adaptor for directing water into said second conduit, wherein said air gap tube includes a second end spaced a distance apart from said second conduit.

12. The assembly as recited in claim 11, wherein said air gap tube is an inverted J-shaped tube.

13. The assembly as recited in claim 11, wherein said second end of said air gap tube is spaced apart from said adaptor a distance equal to or greater than said height of said housing.

14. The assembly as recited in claim 13, wherein said distance includes a first portion equal to said height of said housing and a second portion, wherein said first portion is greater than said second portion.

15. The assembly as recited in claim 11, wherein said housing includes a mount portion for mounting a faucet assembly.

16. The assembly as recited in claim 11, wherein said housing includes an outer surface for mating to a faucet, wherein said faucet is mountable atop said housing.

17. The assembly as recited in claim 11, wherein said housing includes an inlet opening for an inlet conduit of a faucet.
